(19) United States
(12) Patent Application Publication
(10) Pub. No.: US 2008/0164242 A1
(43) Pub. Date: Jul. 10, 2008

(54) Laser Indicated Pneumatic Cutter

(76) Inventor: Chin-ho Hsu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/621,275

(22) Filed: Jan. 9, 2007

(51) Int. Cl. B23K 26/00

(52) U.S. Cl. 219/121.67

(57) ABSTRACT

A laser indicated pneumatic tool includes a body having a tooling head, a locating holder integrally formed with the tooling head of the body, a laser indicator received in the locating holder. The laser indicator includes a transmission member, cells and a switch lid disposed behind the cells. A push button is provided on the switch lid. The cells and the transmission member are conducted to emit laser beam when the push button is pressed to align at a cutting line on a plate work piece to guide the process.

### BACKGROUND OF THE INVENTION

(a) Field of the Invention

The present invention relates to a pneumatic tool, and more particularly, to one having a locating holder integrally formed with a body to contain a laser indicator to emit laser beam aligned at a cutting line on a plate work piece to guide the process.

(b) Description of the Prior Art

Whereas there are many types of pneumatic tools generally available in the market, they operate by producing eccentric movement with air pressure to drive a tooling head to process cutting or drilling. Before the process, a cutting line is usually drawn on the work piece for the tooling head to align at the line to guide the cutting or drilling operation. However, the prior art is found with a major flaw in failing a precise cutting or drilling. During the process, the tooling head is located at the most front of the pneumatic tool and is hidden from view by the pneumatic tool; the operator fails to cut or drill by faithfully following the cutting line since the operator's view is obstructed, leading to deviation of the cutting or drilling and waived work piece.

### SUMMARY OF THE INVENTION

To correct the problem of deviation due to failure in aligning at the cutting line found with the prior art, the primary purpose of the present invention is to provide a pneumatic tool adapted with a laser indictor to guide the process. To achieve the purpose, the pneumatic tool comprises a body having a tooling head, a drive unit built in the body to drive a work unit built in the body. A locating holder is integrally formed with the tooling head of the body. An opening is provided in the locating holder. A laser indicator received in the locating holder comprises a transmission member, cells and a switch lid. A push button is provided on the switch lid.

The present invention provides the following advantages:

1. It emits laser beam to guide the cutter to align at a cutting line on a work piece to execute precise cutting without deviation; and

2. The laser indicator may be adapted to any pneumatic tool in gun-type, or in straight rod type for cutting or drilling to provide handy excellent interchangeability.

### BRIEF DESCRIPTION OF THE DRAWINGS

FIG. 1 is an exploded view of a first preferred embodiment of the present invention.

FIG. 2 is a sectional view of the first preferred embodiment of the present invention as assembled.

FIG. 3 is a schematic view showing the first preferred embodiment of the present invention in an operating status.

FIG. 4 is an exploded view of a second preferred embodiment of the present invention.

FIG. 5 is a sectional view of the second preferred embodiment of the present invention as assembled.

FIG. 6 is an exploded view of a third preferred embodiment of the present invention.

FIG. 7 is a sectional view of the third preferred embodiment of the present invention as assembled.

### DETAILED DESCRIPTION OF THE PREFERRED EMBODIMENTS

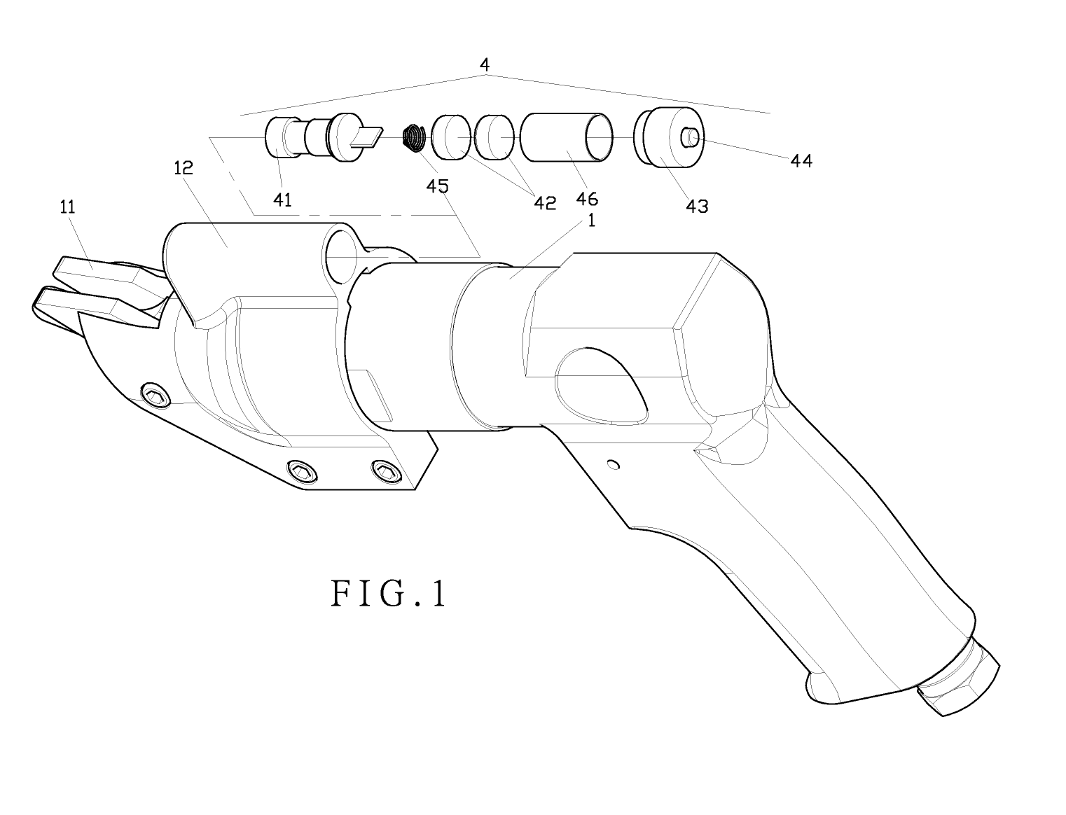

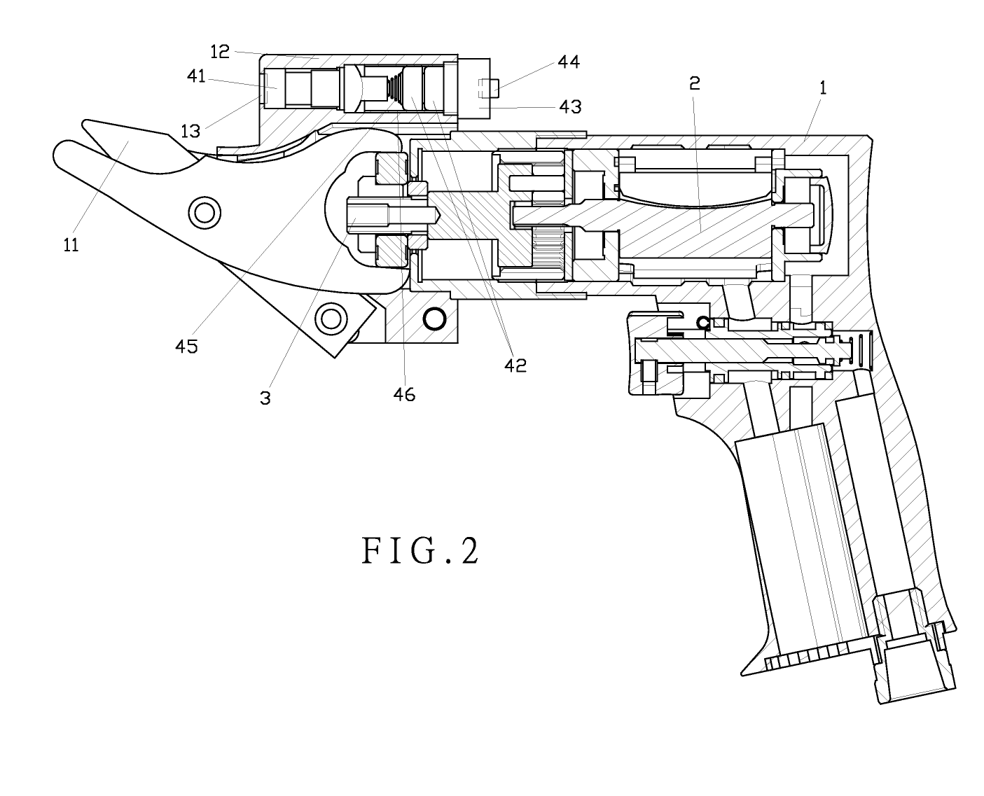

Referring to FIGS. 1 and 2, a first embodiment of the present invention comprises a body (1), a drive unit (2), a work unit (3), and a laser indicator (4).

The body (1) made in the form of a gun is provided with a tooling head (11) at a front end of the body (1). In this embodiment, the tooling head (11) is a cutting head. A locating holder (12) is made an integral part of the body (1) at the top of the tooling head (11). An opening (13) is disposed at the front of the locating holder (12).

The drive unit (2) provided in the body (1) produces eccentric motion when subject to air pressure.

The work unit (3) provided in the body (1) drives the tooling head (11) of the body (1) to produce longitudinal cutting action when driven by the drive unit (2).

The laser indicator (4) received in the locating holder (12) of the body (1) comprises a transmission member (41), a spring (45), cells (42), a sleeve (46), and a switch lid (43) behind the cells (42) to fix and seal the laser indicator (4) to the locating holder (12) of the body (1). The transmission member (41) is to emit laser beam through the opening (13) of the body (1). A push button (44) is provided on the switch lid (43) to conduct the cells (42) and the transmission member (41) to emit laser beam when pressed. The spring (45) is located between the transmission member (41) and the cells (42).

When assembled as illustrated in FIG. 2, the laser indicator (4) is placed in the locating holder (12) of the body (1) with the transmission member (41) of the laser indictor (4) to directly face the opening (13) of the body (1). The spring (45), the cells (42), the sleeve (46) and the switch lid (43) are placed behind the transmission member (41) in sequence into the locating holder (12), and the switch lid (43) is locked to and sealed in the locating holder (12) to easily complete the assembly.

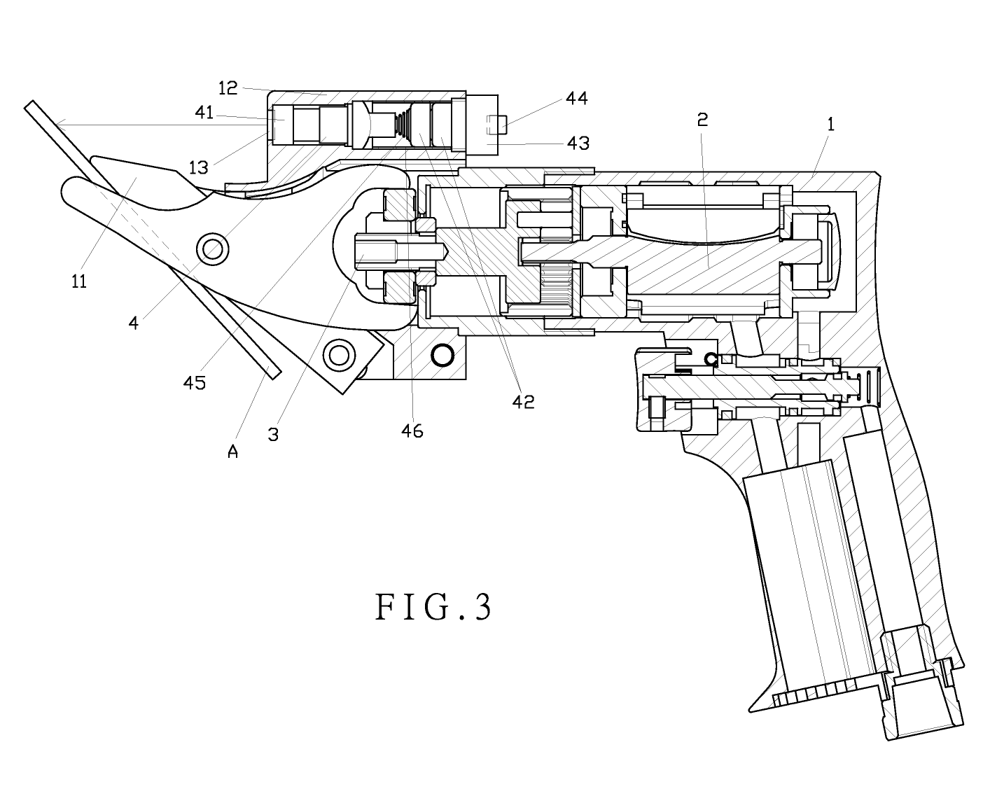

In practice as illustrated in FIG. 3, the tooling head (11) of the body (1) is used to process a cutting operation on a plate work piece (A) and the body (1) is connected with an air pressure source (a practice generally known to the trade and will not be elaborated here). The press button (44) on the switch lid (43) is pressed to conduct the cells (42) to produce power, and the laser indicator (4) is activated to emit laser beam through the transmission member (41). Align the laser beam at a cutting line marked on the work piece (A) to guide the tooling head (11) of the body (1) to process cutting on the work piece (A) by following the cutting line step by step without deviation even the tooling head (11) is blocked from the view of an operator of the body (1).

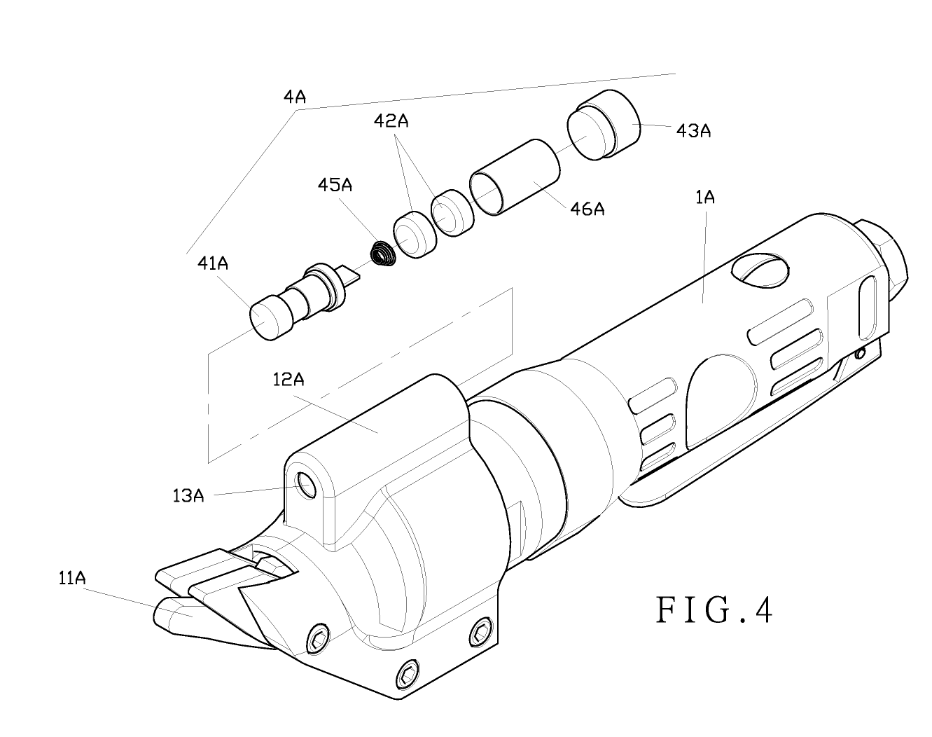

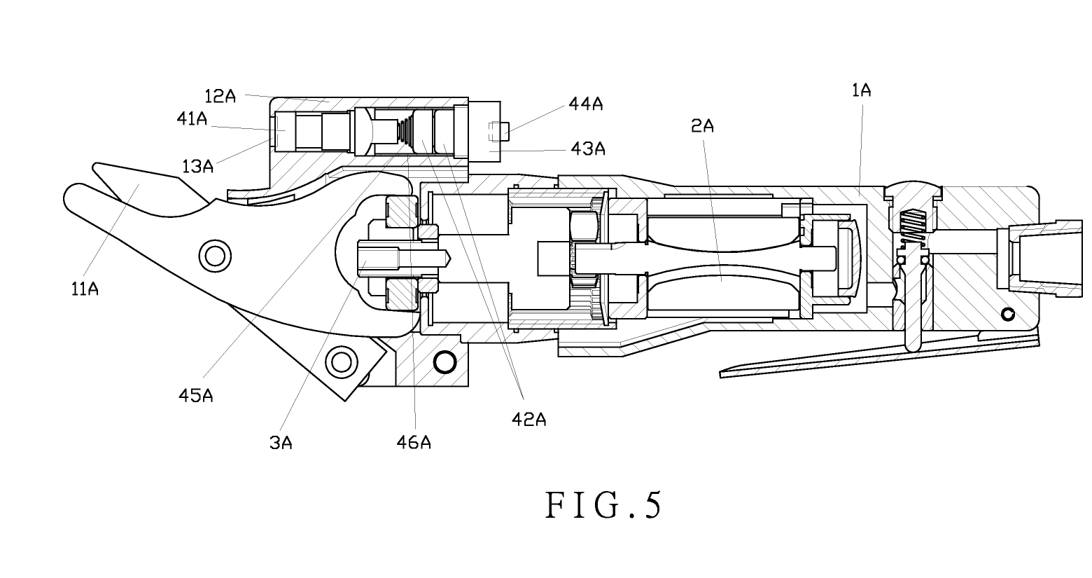

As illustrated in FIGS. 4 and 5, a second preferred embodiment of the present invention comprises a body (1A), a driver unit (2A), a work unit (3A), and a laser indicator (4A).

The body (1A) is in the shape of a straight rod. A tooling head (11A) is provided at a front end of the body (1A). In this embodiment, the tooling head (11A) is a cutting head. A locating holder (12A) made in an integral part to and protruding from the tooling head (11A) is provided on the top of the tooling head (11A). An opening (13A) is disposed at the front of the locating holder (12A).

The drive unit (2A) provided in the body (1A) produces eccentric motion when subject to action of air pressure.

The work unit (3A) is provided in the body (1A) and driven by the drive unit (2A) to further drive the tooling head (11A) of the body (1A) to produce longitudinal motion.

The laser indictor (4A) received in the locating holder (12A) of the body (1A) comprises a transmission member (41A), a spring (45A), cells (42A), a sleeve (46A), and a switch lid (43A) behind the cells (42A) to lock and seal the laser indicator (4A) in the locating holder (12A) of the body (1A). The transmission member (41A) is to emit and transmit laser beam through the opening (13A) of the body (1A). A press button (44A) is provided on the switch lid (43A). The spring (45A) is located between the cells (42A) and the transmission member (41A). The cells (42A) are conducted through the transmission member (41A) to emit the laser beam aligning at a cutting line marked on the plate work piece (A) to guide the cutting process without deviation.

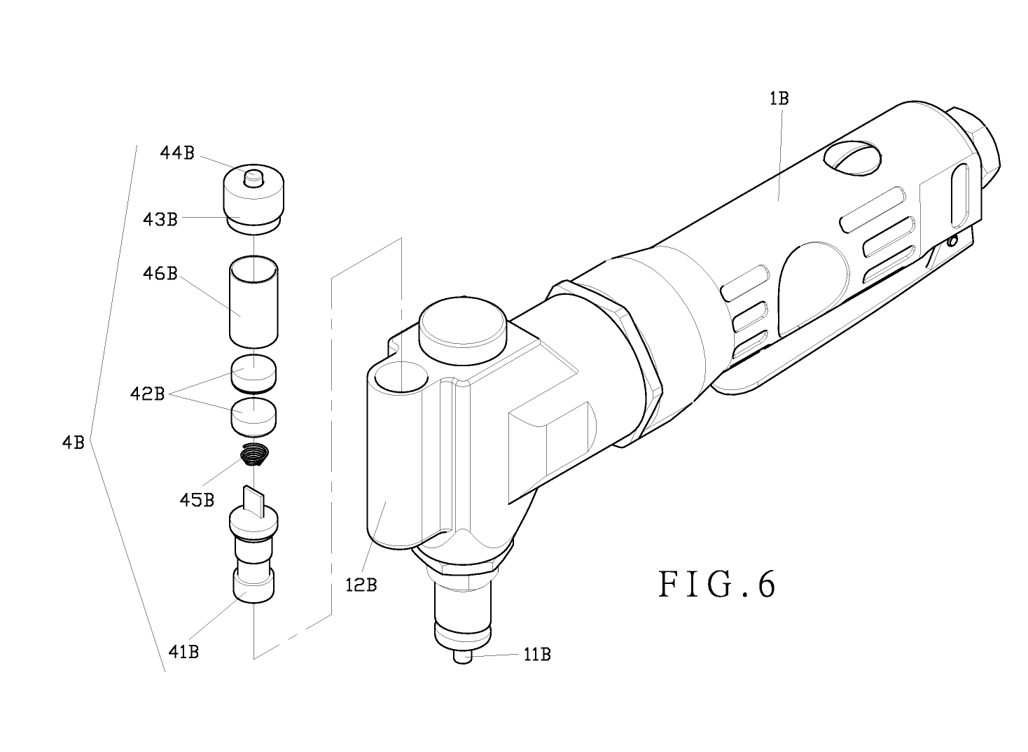

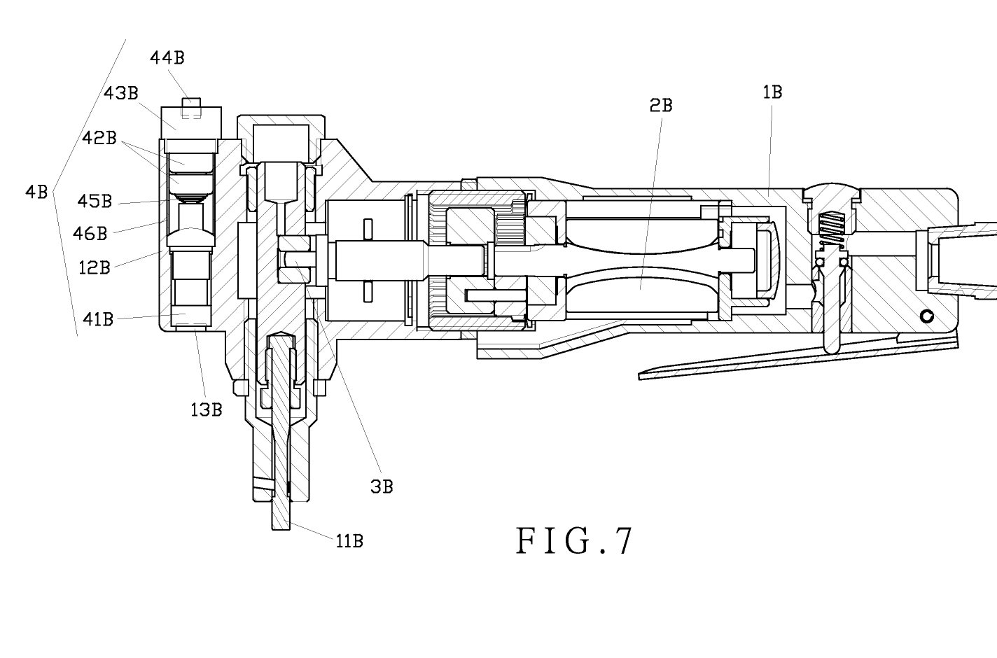

A third preferred embodiment of the present invention, as illustrated in FIGS. 6 and 7, comprises a body (1B), a driver unit (2B), a work unit (3B), and a laser indicator (4B).

The body (1B) is in the shape of a straight rod. A tooling head (11B) is provided at a front end of the body (11B). In this embodiment, the tooling head (11B) is a drilling head. A locating holder (12B) made in an integral part to and protruding from the tooling head (11B) is provided on the top of the tooling head (1B). An opening (13B) is disposed at the front of the locating holder (12B).

The drive unit (2B) provided in the body (1B) produces eccentric motion when subject to action of air pressure.

The work unit (3B) is provided in the body (1B) and driven by the drive unit (2A) to further drive the tooling head (11B) of the body (1B) to produce longitudinal motion.

The laser indictor (4B) received in the locating holder (12B) of the body (1B) comprises a transmission member (41B), a spring (45B), cells (42B), a sleeve (46B), and a switch lid (43B) behind the cells (42B) to lock and seal the laser indicator (4B) in the locating holder (12B) of the body (1A). The transmission member (41B) is to emit and transmit laser beam through the opening (13B) of the body (1B). A press button (44B) is provided on the switch lid (43A). The spring (45A) is located between the cells (42A) and the transmission member (41B). The cells (42B) are conducted through the transmission member (41B) to emit the laser beam aligning at a cutting line marked on the plate work piece (A) to guide the drilling process without deviation.

What is claimed is:

1. A laser indicated pneumatic tool, comprising:
a body having a tooling head;
a drive unit built in the body;
a work unit built in the body and driven by the drive unit; and
characterized by:
a locating holder integrally formed with the tooling head of the body, the locating holder having an opening;
a laser indicator received in the locating holder comprising a transmission member, cells and a switch lid, a push button being provided on the switch lid, the transmission member corresponding in position to the opening of the locating holder.

2. The laser indicated pneumatic tool as claimed in claim 1, wherein the body is in the shape of a gun.

3. The laser indicated pneumatic tool as claimed in claim 1, wherein the tooling head is a cutting head.

4. The laser indicated pneumatic tool as claimed in claim 1, wherein the body is in the shape of a straight rod.

5. The laser indicated pneumatic tool as claimed in claim 1, wherein a spring is provided between the transmission member and the cells, and the laser indicator further comprises a sleeve.
